(19) United States
(12) Patent Application Publication
(10) Pub. No.: US 2018/0106286 A1
(43) Pub. Date: Apr. 19, 2018

(54) Driver/Fastener Inter-engagement System

(71) Applicant: Consolidated Fasteners Inc, Lexington, KY (US)

(72) Inventors: Benjamin Cone, III, Raleigh, NC (US); Hamilton Rogers Drake, Mount Pleasant, SC (US); Daniel A O'Hearn, Gananoque (CA)

(73) Assignee: Consolidated Fasteners Inc, Lexington, KY (US)

(21) Appl. No.: 15/295,018

(22) Filed: Oct. 17, 2016

(51) Int. Cl. F16B 23/00; B25B 15/00; F16B 25/00

(52) U.S. Cl. CPC F16B 23/0038; F16B 25/0015; F16B 23/0053; B25B 15/004

(57) ABSTRACT

Embodiments of the present invention provide a screw and driver system comprising a range of screws and a driver for said range. Each screw comprises a head having a driving recess in its surface for engagement by said driver. Each recess has a recess longitudinal axis. The recess of larger screws in the range has a plurality of superimposed recess-tiers of decreasing size with increasing depth from said surface, each recess-tier except the smallest having substantially parallel driving surfaces substantially parallel said recess longitudinal axis. The driving head of the driver has a driver longitudinal axis and a plurality of superimposed drive-tiers of decreasing size towards a tip of the driver, each drive-tier except the smallest having substantially parallel driving surfaces substantially parallel said longitudinal axis. The driver and recess are shaped so that, when the driver is engaged with the recess of any screw in said range, torque applied to the driver is transmitted to the screw through said driving surfaces. The smallest recess-tier of larger screws has a mouth in a floor of an adjacent recess-tier and has recess flanks that are all tapered from the mouth towards the recess longitudinal axis at a recess taper angle between 1.91 and 6.85°. The smallest drive-tier of the driver has a root in a base of an adjacent drive-tier and has drive flanks that are all tapered from the root towards the driver longitudinal axis at a tier taper angle between minus 1.5 and plus 2.5° difference with respect to said recess taper angle. The diameter of the drive-tier at the root and the diameter of the recess-tier at the mouth are such that, on insertion of said driver head in the screw recess, said drive and recess flanks inter-engage to deform and stick together through frictional engagement before said base engages said floor.

### TECHNICAL FIELD

Aspects of the invention relate to a driver/fastener inter-engagement system, to a driver for such a system and to fasteners for use in the system.

### BACKGROUND

This invention relates to multi-tiered-recess fasteners, especially screws, that is to say, screws comprising a driving recess for insertion of a driving tool (a driver), which recess comprises a plurality of superimposed recess-tiers of decreasing size. The recess-tiers may be concentric, in which event they are non-circular. Indeed, the invention is particularly concerned with the latter, because these have the additional feature that, whereas the driver has a fixed number of tiers, the screw may have some or all of the recess-tiers, depending on its size and torque driving requirements.

It is a particular feature of this kind of screw that there is a single driver that is suitable for driving a range of sizes of screw. Smaller screws simply have one or two small recesses, while the larger screws have larger recesses also.

GB-A-1150382 appears to be the first disclosure of a screw provided with a multi-tiered recess and a corresponding multi-tiered driver. GB-A-2285940 discloses essentially the same idea. Both these publications describe the advantages provided by the arrangements disclosed. The first is that the recesses are essentially parallel-sided and consequently eliminate cam-out problems that are associated with cross-head recesses. Secondly, they give the possibility of a single driving tool being suitable for driving a wide range of screw sizes.

The single driving tool typically has three (for example) tiers of driving surfaces which are employed to drive large screws having three recess-tiers of recess. However, the same tool can be employed with smaller screws having only two recess-tiers of recess, the largest recess-tier of the large screws being omitted. Indeed, even smaller screws may have only one, the smallest recess-tier, in their recess and be driven by the smallest tier only of the tool.

GB-A-2329947 discloses a similar arrangement, and WO-A-0177538 discloses recess-tiers that have such a small extent in the recesses of screws and bolts that, at the torques at which the screws are intended to be operated, they cannot be turned unless at least two recess-tiers are both engaged by the tool. Otherwise, the screw is arranged to round out of engagement with the driving tool. This provides a security feature in that only the appropriate tool, having all the requisite driving tiers, will undo the screw.

WO-A-0325403 discloses a method of manufacture of such screws using cold forming punches. It is possible to make the recesses with some precision, so that the driving tool is a close fit in the recess. This has the very useful feature that recess-tiers can be shallow. Then, screw heads do not need to be large to accommodate the driving tool. Yet, adequate torque can still be applied because a large proportion of the area of each recess is used for torque transmission by virtue of the close tolerance fit. But, equally usefully, the tool fits the screw so closely that, once mated with the driving tool, the screw can be carried solely by the driver when it is offered up to a workpiece. Indeed, especially (although not exclusively) with self-tapping wood screws, the connection between driver and screw is so stable that some pressing and simultaneous rotation forces can be applied to the tool, without holding the screw. This can be done without significant risk that the connection will fold as may happen with, for example, Posi-Driv (registered trade mark) screws unless forces are maintained absolutely axial. With the three-tiered screws of the type to which the present invention relates, the fit is desirably so close that even carrying screws dangling vertically from the driver is possible if carried carefully.

Nevertheless, it would be desirable to improve this feature. This is particularly so with screws having only one or two recess-tiers of recess. It seems that it is partly the plurality of recess-tiers that, at least to some extent, explains why the screw appears to grip the driver so effectively. So, with smaller screws having just one recess-tier of recess the feature is not so evident.

WO-A-2005047715 addresses this problem. It provides a screw and driver system comprising a range of screws and a driver for said range, each screw comprising a head having a driving recess in its surface for engagement by said driver and a longitudinal axis, in which the recess of larger screws in the range have a plurality of superimposed recess-tiers of decreasing size with increasing depth from said surface, each recess-tier having substantially parallel driving surfaces substantially parallel said longitudinal axis, and in which said driver and recess are shaped so that, when the driver is engaged with the recess of any screw in said range, torque applied to the driver is transmitted to the screw through said driving surfaces; wherein, an interference is provided between the driver and the recess causing deformation of the recess when the driver is inserted therein. In one embodiment, said interference comprises at least one recess-tier of at least smaller screws in said range having a rib parallel said longitudinal axis and encroaching into the space of said recess-tier occupied by said driver when it is engaged with said recess, whereby engagement of the driver with the recess causes deformation of said rib and hence creation of an interference fit of said driver in said recess.

In one embodiment, the smallest tier of said driver comprises a distal end thereof and a proximal end, and said interference comprises a tapering of the cross-section of said smallest tier from said proximal to said distal end, the cross section of the tier intermediate said ends corresponding with the cross section of the smallest recess-tier of a screw in said range. Therefore, when the driver is engaged with the recess of a screw, flanks of the walls of the smallest recess-tier are deformed creating an interference fit between them.

Likewise, the converse may be provided where the smallest recess-tier of the recess of each screw in said range has a bottom end and an open top end, said interference comprising a tapering of the cross-section of said smallest recess-tier from said open top end to said bottom end, the cross section of the recess-tier intermediate said ends corresponding with the cross section of the smallest tier of said driver.

A problem with such arrangements is that the there is a degree of instability caused by said interference between the driver and the screw.

It is an object of embodiments of the invention to at least mitigate one or more of the problems of the prior art.

### SUMMARY OF THE INVENTION

In accordance with the present invention, there is provided a screw and driver system comprising a range of screws and a driver for said range, each screw comprising a head having a driving recess in its surface for engagement by said driver, wherein:
a) each driving recess has a recess longitudinal axis,
b) the driving recess of larger screws in the range has a plurality of superimposed recess-tiers of decreasing size with increasing depth from said surface, each recess-tier, except the smallest, having substantially parallel driven surfaces substantially parallel said recess longitudinal axis,
c) a driving head of the driver has a driver longitudinal axis and a plurality of superimposed drive-tiers of decreasing size towards a tip of the driving head, each drive-tier, except the smallest, having substantially parallel driving surfaces substantially parallel said driver longitudinal axis, and
d) said driver and recess are shaped so that, when the driving head is engaged with the recess of any screw in said range, torque applied to the driver is transmitted to the driven surfaces of the screw through said driving surfaces of the driver; and wherein

the smallest recess-tier of larger screws has a mouth in a floor of an adjacent recess-tier and has said driven surfaces comprising recess flanks that are all tapered from the mouth towards the recess longitudinal axis at a recess taper angle between 2.5° and 5.5°;

the smallest drive-tier of the driver has a root in a base of an adjacent drive-tier and has said driving surfaces comprising drive flanks that are all tapered from the root towards the driver longitudinal axis at a tier taper angle between minus 1.5° and plus 2.5° difference with respect to said recess taper angle; and

the diameter of the drive-tier at the root and the diameter of the recess-tier at the mouth are such that, on insertion of said driving head in the screw recess, said drive and recess flanks inter-engage to deform and stick together through frictional engagement before said base engages said floor.

Thus, the present invention does not suggest an engagement between a surface and an edge along a line (as envisaged in WO-A-2005047715) between the driver and recess, but an engagement between two, substantially identically, tapering surfaces. A comparison can be had with tapered drinking cups that stack and naturally engage through surface frictional engagement. Ideally, the tapering between driver and screw recess is identical, that is, between the drive flanks of the driver and the recess flanks of the screw, but an issue with the present invention is concerned with tolerances.

The present invention is typically to be employed in the field of self-tapping wood screws of the most common type, employed in house building and many other projects. In this field, the cost of manufacture of the screws is a significant commercial issue and wide tolerances in screw dimensions have to be accommodated in order to reduce costs. Nevertheless, cost can be an issue with all types of screws and the present invention is not limited to self-tapping wood screws.

WO-A-0325403 discloses the counter-intuitive measure that improving the accuracy of manufacture (of the cold forming punches used to create the recesses in multiple screws) reduces the cost of manufacture of the screws. By accuracy, here, is meant the accuracy of the dimensions, particularly the accuracy of the diameter, of the recess-forming tiers of the punch. Accurately formed punches, unsurprisingly, produce accurately-formed screws. However, this enables the tier recesses of the screws to be designed with reduced depth, because the screws are more accurately matched to the driver. Therefore, the area of surface engagement between the driver flanks and recess flanks, of all the tiers of the driver and screw, can still be large enough to transmit the required levels of torque, despite being shallow in depth.

Because the tiers of the punch are thus shallow in depth, the punch survives much longer (it can form the recesses in many more screws) than would be the case if the recess tiers were relatively deep. Wear on the punch is caused significantly because the flanks of the recess-forming tiers of the punch are parallel the direction of drive of the punch. So reducing the depth of the flanks reduces the wear.

Nevertheless, there is still inevitable tolerance (by which is meant, variation) in the dimensions of the screw, caused by wear of the punch as it manufactures the recess of many thousands of screws.

Thus the taper of the smallest recess-tier of the screw is set to be between minus 1.5 and plus 2.5° greater than the corresponding taper of the drive-tier of the driver, whereby most mis-matches between the driver and recess results in the tip of the driver engaging the recess-tier of the screw near its base in the screw, rather than the mouth of the recess-tier engaging the flank of the drive-tier of the driver near its root. This has the effect of reducing any tendency of the inter-engagement between driver and screw to wobble.

In some embodiments, the smallest drive-tier of the driver may have drive flanks that are all tapered from the root towards the driver longitudinal axis at a tier taper angle between 0° and 1.0° less than said recess taper angle.

In most cases, it is expected that the smallest drive-tier of the driver will have a tier taper angle of 3.7°±0.9°, whereas the smallest recess-tier of the screw will have a recess taper angle of 4.3°±0.9°. This does mean that some driver/screw combinations could have a taper difference that is negative, meaning that the mouth of the recess will, on those occasions, bite on the flanks of the driver, but in the majority of cases, within the normal tolerances of manufacture, the flanks of the driver and recess will be more parallel or have a positive taper difference, meaning that the tip of the driver will bite in the flanks of the recess near its floor.

Another issue with regard to tolerances is the inevitable fillet of material between drive flanks of a driver at their root and the base of the adjacent tier. The same is true of the punch for making the recesses in screws. That fillet has a radius, and the larger that the radius of the fillet is, the less engagement there is between driving flanks of the driver and recess respectively. This is a minor problem in the larger tiers of the driver and recess, since axial dislocation between them (and because their surfaces are parallel the longitudinal axes of the driver and recess respectively) does not affect their inter-engagement except in respect of the overall surface area of contact between them.

However, with regard to the smallest tiers of the driver and recess, which are tapered, the fillet on the driver can limit the engagement of the driver with the recess such that the tapered flanks of each do not engage and there is no frictional surface fit between them.

Thus, in one embodiment:

the driver has a smallest-drive-fillet at the root between the smallest drive-tier and the base of said adjacent drive-tier, wherein the radius of the smallest-drive-fillet is between 0.1 and 0.2 mm,

the screw has a smallest-recess-chamfer at the mouth between the smallest drive-recess and the floor of said adjacent recess-tier, wherein the radius of the smallest-recess-chamfer is between 0.15 and 0.2 mm; and

the diameter of the smallest drive-tier of the driving head where the smallest-drive-fillet begins, is larger than the diameter of the smallest drive-recess where the smallest-screw-chamfer ends, by between 0.04 and 0.1 mm.

Providing these limits of the fillet/chamfer and diameters of the smallest drive-tier and the smallest drive-recess ensure, at least insofar as engagement of the smallest drive-tier with the smallest drive-recess is concerned, that the drive flanks of the smallest drive-tier engage with the driven flanks of the smallest drive-recess when the driver is mated with the screw, before the smallest-drive-fillet on the driver impacts the smallest-screw-chamfer in the screw, and before the base of the adjacent drive-tier of the driver impacts the floor of the adjacent recess-tier of the screw. Thus the possibility of effective engagement between driver and recess is ensured, both as regards maximum surface area contact between the driving and driven flanks of the driver and recess as well as substantially surface to surface frictional gripping engagement between the smallest drive/recess tiers of the driver and screw.

The latter is tested by a qualitative assessment based on inserting a driver into engagement with a screw and pressing the same into engagement using finger pressure alone when gripping the screw and then inverting the driver so that the screw has the opportunity to fall out of engagement under the force of gravity, but that the frictional gripping engagement between the smallest drive/recess tiers of the driver and screw is sufficient to retain the screw in position on the driver.

Incidentally, while not forming part of the present invention, the engagement of the middle and largest tiers of the driver can themselves be limiting factors in engagement of the smallest tier of the driver with the smallest recess of the screw in screws that have middle, or middle and largest, recess tiers. Accordingly, it is also necessary for dimensions of the middle and largest tiers of the driver (including radius of intervening drive-fillet between the largest and middle tiers) be matched appropriately with the corresponding recesses (and recess-chamfer at the mouth of the middle recess-tier) of screws that have middle, or middle and largest, size recess tiers. The largest tier of the driver may not have a drive-fillet, but instead have extended drive flanks, since even larger screws will often be provided with deeper largest-recess-tiers, whereby greater torque can be applied to such screws.

### BRIEF DESCRIPTION OF THE DRAWINGS

Embodiments of the invention will now be described by way of example only, with reference to the accompanying figures, in which:

FIGS. 1a to d show respectively an end view, a side view, a second orthogonal side view and detail B from FIG. 1c, of a two-tier punch for forming a two recess-tier screw in accordance with the present invention;

FIGS. 2a to c show respectively an end view, a side view, and a second orthogonal side view, of a driver in accordance with the present invention;

FIGS. 3a to c show respectively an end view, a side view, and a second orthogonal side view, of a three-tier punch for forming a three recess-tier screw in accordance with the present invention;

FIGS. 4a and b show respectively a driver in side view and a screw in side section in accordance with another embodiment of the present invention; and

FIG. 5 is an enlarged view (not to scale) of engagement between a screw recess and driver in accordance with the present invention.

### DETAILED DESCRIPTION

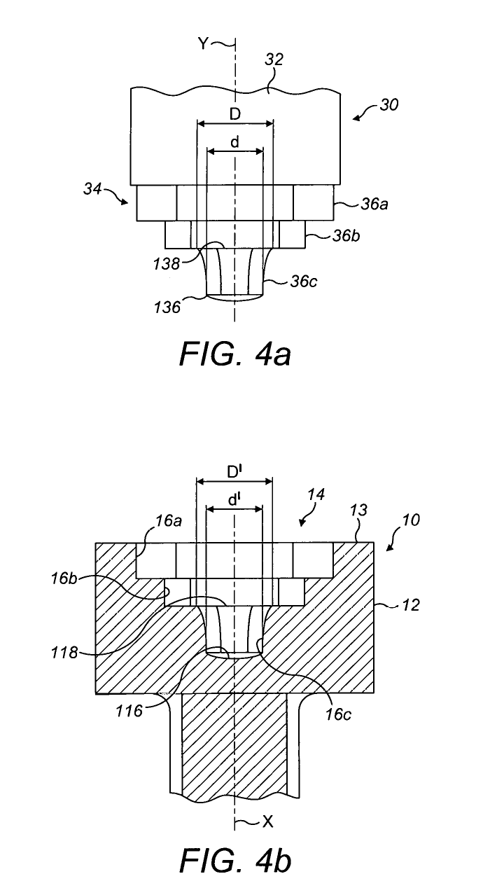

With reference initially to FIGS. 4a and 4b, a screw 10 has a driving recess 14 in its head 12 which opens at the top surface 13 of the head 12. The recess 14 comprises three super-imposed hexagonal recesses 16a,b,c, each of reducing dimension. It is possible to have fewer recesses, or more.

A driver 30 for the screw 10 comprises a shaft 32 and a driving head 34 comprising three tiers 36a,b,c (or more if there are more recess-tiers in the largest screws). The cross sections of the driving tiers 36a,b,c correspond with the cross sections of the recesses 16a,b,c of the screw 10 and reduce in cross-sectional diameter towards a tip of the driving head 34. Accordingly, when the driver head 34 is inserted into the recess 14, the screw 10 is seated on the end of the driver 30 and can be driven, by rotation of the driver, and screwed into a workpiece (not shown).

Each of the largest and middle recess-tiers 16a and 16b of the recess 14 have parallel sides, defining driven surfaces, which sides are parallel a recess longitudinal axis X of the recess. Likewise, each of the largest and middle drive-tiers 36a and 36b of the drive head 34 have parallel sides, defining driving surfaces, which sides are also parallel a driver longitudinal axis Y of the driver 30. The dimensions of the drive-tiers and recess-tiers are closely matched, whereby torque applied to the driver is transmitted to the recess through the abutting driving surfaces or flanks of each drive-tier against the corresponding driven surfaces or flanks of the screw recess. Because these sides are parallel to the axes of rotation X, Y of the driver and recess, there is no tendency for cam-out.

The smallest recess-tier 16c, and the smallest drive-tier 36c, do not have parallel flanks, however, and are instead tapered. The taper can be straight, or as shown in FIGS. 4a and 4b, it may be curved. In any event, they are matched, and by closely matching the tapers of the smallest-recess-tier, as well as matching the dimensions of the other recess-tiers with the corresponding drive-tiers of the driver, the largest and middle drive-tiers can be fully engaged and yet the tapers of the smallest tiers of the recess and driver sufficiently snugly inter-engaged so that the slight pinching between them is enough to prevent the screw from being dislodged by inversion of the driver with respect to the recess. Furthermore, because the contact between the flanks of the smallest drive-tier and smallest recess-tier is through their respective driving/driven surfaces, rather than between a line contact, the connection between driver and recess is more stable and less likely to wobble when the screw is engaged with a workpiece.

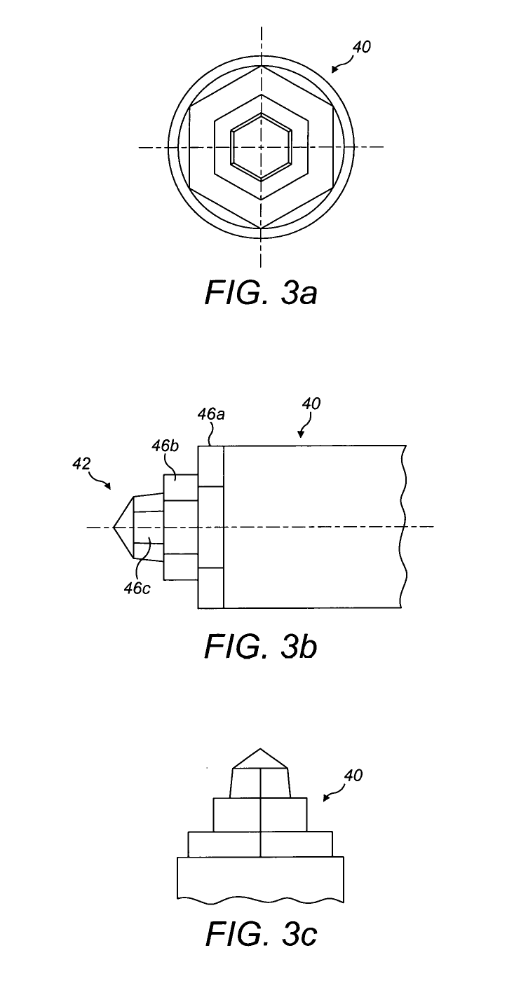

Turning to FIGS. 3a to 3c, a punch 40 has a recess forming head 42 comprising three hexagonal punch-tiers 46a,b,c, and is for forming the recess 14 of the screw shown in FIG. 4b.

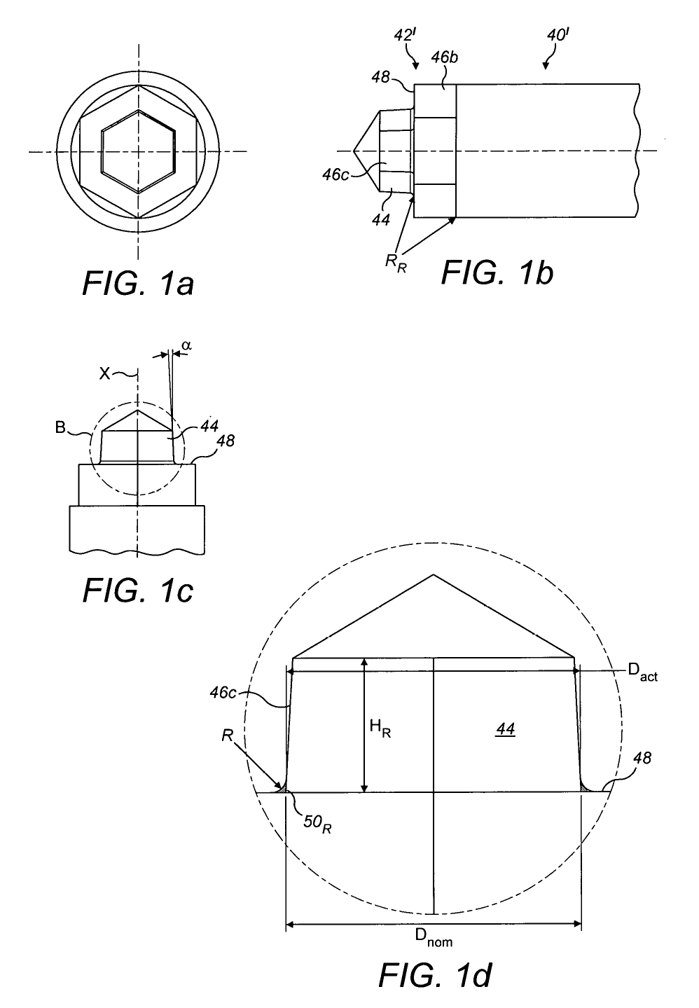

Turning to FIGS. 1a to 1d, a punch 40′ has a recess forming head 42′ comprising two hexagonal punch-tiers 46b,c, and is for forming the recess of a screw not shown in the drawings but having only two recess tiers, which tiers are arranged to correspond precisely with the recess-tiers 16b,16c of the screw shown in FIG. 4b.

However, the screw recess formed by the punches 40,40′ differ from the screw shown in FIG. 4b in that the smallest punch-tier 46c of the punches 40,40′ has straight flanks 44.

It will be understood that, in a cold-forming process to form a screw recess, by driving a punch into the blank head of a screw, the metal of the screw head becomes temporarily liquid under the extreme pressure and impact of the punch, and flows around the shape of the punch. The recess so-formed adopts almost exactly the shape and dimensions of the punch, whereby the shape and dimensions of the punch essentially mirror precisely the dimensions of the recess formed.

In FIGS. 1a to 1d, details of the smallest punch-tier 46c are shown, especially in FIG. 1d. This corresponds to the shape and dimensions of the smallest recess-tier 16c of a screw 10 to be formed (although not precisely as illustrated in FIG. 4b because that screw has a curvingly-tapered smallest recess 16c).

Thus, references to features of a screw's recess, particularly its smallest recess-tier, are frequently made hereinafter by reference to FIG. 1, and to the punch 40′ that forms them, (or indeed, the punch 40 in FIGS. 3a to c, which only differs in having a third, largest punch-tier 46a).

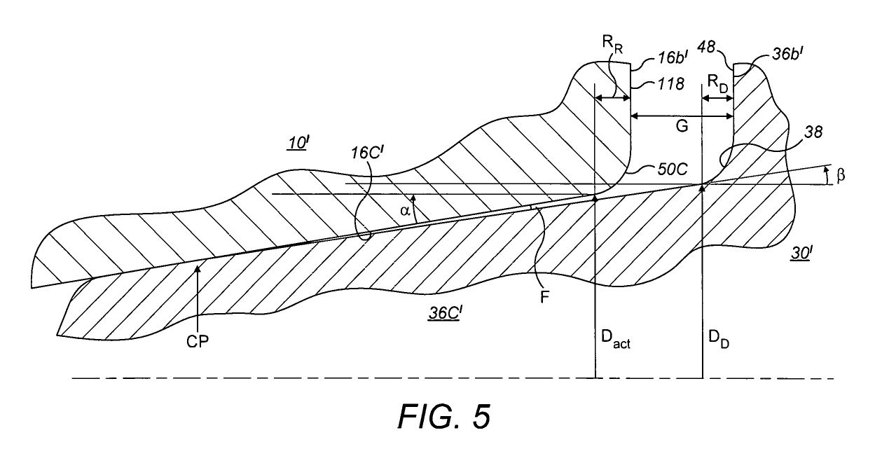

As mentioned, the smallest recess-tier 16c, formed by the punch 40, 40′, is tapered at a recess taper angle α inwardly towards the recess longitudinal axis X. α may be 4.35°. The punch has an adjacent-tier base 48 from which the punch-tier 46c extends. If there is a perfect angle between the flank 44 and the base 48, the diameter Dₙₒₘ of the tier at the base 48 is 2.56 mm. However, a fillet 50_{R} inevitably remains (in the course of manufacture of the punch 30, 30′) between the flank and base and this punch-fillet 50_{R} has a radius R_{R}, which may be between 0.15 mm and 0.2 mm. The punch-fillet provides a corresponding chamfer 50c in the mouth of the smallest tier-recess of the screw (see FIG. 5). Likewise, the base 48 forms floor 118 of the adjacent recess-tier 16b of the screw 10 (see FIG. 4b).

The flank 44 therefore actually begins between 0.15 mm and 0.2 mm from the base 48 and, here, may have a diameter D_{act} of 2.535 mm. The depth H_{R} of the flank 44 of the smallest tier-recess 46c of the screw may be 1.17 mm.

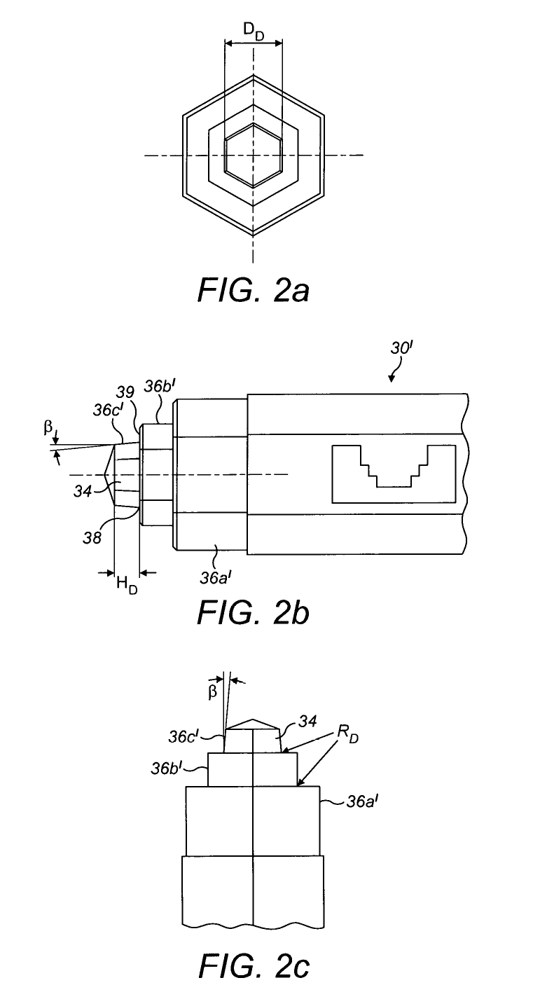

Turning to the driver, FIGS. 2a to 2c show a driver 30′ to cooperate with the recesses 14 of screws formed by the punches 40,40′. The smallest drive-tier 36c′ has a height H_{D} of 1.09 mm, but it also has an inevitable drive-fillet 38 of radius R_{D} at its root between the smallest drive-tier 36c′ and the base 39 of adjacent drive-tier 36b′. R_{D} is likewise restricted to between 0.15 mm and 0.2 mm. Immediately adjacent the drive-fillet 38, the diameter D_{D} of the smallest drive-tier is 2.615 mm. The flanks 34 of the smallest drive-tier 36c′ have a tier taper angle β, which may be 3.7°.

The reason for the difference in recess taper angle α and tier taper angle β is because any manufacture of screw and driver is subject to variance. FIG. 5 (which is not to scale) shows the interaction between the smallest drive-tier 36c′ of driver 30′ and smallest recess-tier 16c′ of screw 10′. In Table 1 below are representative dimensions achievable across a substantial, cost-effective, manufacturing range.

TABLE 1

| | Recess | | | Driver | | |
|---|---|---|---|---|---|---|
| | Minimum | Nominal | Maximum | Minimum | Nominal | Maximum |
| Angle | 1.91° | 4.35° | 6.85° | 1.2° | 3.7° | 6.2° |
| (α, β) | | | | | | |
| Diameter mm | 2.46 | 2.535 | 2.83 | 2.58 | 2.615 | 2.87 |
| (D_{act,} D_{D}) | | | | | | |
| Radius mm | 0.1 | — | 0.5 | 0.1 | — | 0.5 |
| (R_{R}, R_{D}) | | | | | | |
| Depth/Height | 1.05 | 1.17 | 1.25 | 1.01 | 1.09 | 1.2 |
| mm (H_{R}, H_{D}) | | | | | | |

Table 2 below illustrates another possible embodiment of dimension possibilities.

TABLE 2

| | Recess | | | Driver | | |
|---|---|---|---|---|---|---|
| | Minimum | Nominal | Maximum | Minimum | Nominal | Maximum |
| Angle | 3.5° | 4.35° | 4.5° | 3.4° | 3.7° | 4.0° |
| (α, β) | | | | | | |
| Diameter mm | 2.52 | 2.535 | 2.55 | 2.60 | 2.615 | 2.63 |
| (D_{act,} D_{D}) | | | | | | |
| Radius mm | 0.15 | — | 0.2 | 0.1 | — | 0.2 |
| (R_{R}, R_{D}) | | | | | | |
| Depth/Height | 1.10 | 1.17 | 1.25 | 1.05 | 1.09 | 1.15 |
| mm (H_{R}, H_{D}) | | | | | | |

Within the limits of these ranges, especially those in Table 2, on most occasions, a driver 30′ with its smallest drive-tier 36c′ will interact with the smallest tier-recess 16c′ with a first contact point CP separated from chamfer 50c at the mouth of the smallest tier-recess 16c′. Assuming that the drive-fillet 38 and chamfer 50c substantially match, this leaves a gap G of between 0.04 and 0.1 mm between floor 118 of the adjacent recess-tier 16b′ of the screw 10′ and base 48 of adjacent drive-tier 36b′ of driver 30′. Furthermore, the contact point CP will be such as to leave separation F above it (between the contact point CP and chamfer/fillet 50c/38), while below, there is compression of the driver and expansion of the recess. However, the angle F of contact will be so minimal that the compression/expansion between the recess and driver will always be small and spread over a significant area, but generally always separated from the mouth of the recess. Thus a more stable connection is achieved.

It should of course be appreciated that the smallest tiers of the driver and recess are hexagonal in section, like the other tiers (although other polygonal sections are possible) and in the smallest screws only the single smallest-tier recess may be provided, driven only by the smallest drive-tier of the driver. Thus, because the flanks of this tier are not parallel the longitudinal axis of the driver/screw combination, and indeed both the recess and driver are tapered, there is a cam-out tendency once torque is applied between driver and screw. That is, there is an axial component of the reaction force between screw and driver on application of torque, which component tends to separate the screw and driver. However, with the taper angle being less than 5°, that component of force is minor. In small screws, with only the single smallest-tier recess, the proportion of axial force compared with torque applied may be greater and there is less inherent resistance to screw/driver separation (through frictional engagement of parallel flanks in multi-tiered screws). Nevertheless, there is little difficulty in a user resisting such cam-out forces with small screws.

Furthermore, it should also be understood that use of the term “diameter” as used herein, with respect to hexagonal, or any polygonal, section, is (unless the context otherwise makes clear) a reference to the dimension perpendicularly across the sides of the section (flat to flat dimension). Generally, “diameter” is simply a measure of the size of the section in question but it could, for example, just as meaningfully, be the distances across the corners of an hexagonal section.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

Each of claims 3, 4 and 6 to 8 of the appended claims may be dependent on any one or more of the claims which precede them.

1. A screw and driver system comprising a range of screws and a driver for said range, each screw comprising a head having a driving recess in its surface for engagement by said driver, wherein:
a) each driving recess has a recess longitudinal axis,
b) the driving recess of larger screws in the range has a plurality of superimposed recess-tiers of decreasing size with increasing depth from said surface, each recess-tier, except the smallest, having substantially parallel driven surfaces substantially parallel said recess longitudinal axis,
c) a driving head of the driver has a driver longitudinal axis and a plurality of superimposed drive-tiers of decreasing size towards a tip of the driving head, each drive-tier, except the smallest, having substantially parallel driving surfaces substantially parallel said driver longitudinal axis, and
d) said driver and recess are shaped so that, when the driving head is engaged with the recess of any screw in said range, torque applied to the driver is transmitted to the driven surfaces of the screw through said driving surfaces of the driver; and wherein
the smallest recess-tier of larger screws has a mouth in a floor of an adjacent recess-tier and has said driven surfaces comprising recess flanks that are all tapered from the mouth towards the recess longitudinal axis at a recess taper angle between 1.91° and 6.85°;
the smallest drive-tier of the driver has a root in a base of an adjacent drive-tier and has said driving surfaces comprising drive flanks that are all tapered from the root towards the driver longitudinal axis at a tier taper angle between minus 1.5° and plus 2.5° difference with respect to said recess taper angle; and
the diameter of the drive-tier at the root and the diameter of the recess-tier at the mouth are such that, on insertion of said driving head in the screw recess, said drive and recess flanks inter-engage to deform and stick together through frictional engagement before said base engages said floor.

2. A screw and driver system according to claim 1, wherein said recess flanks of the smallest recess-tier of larger screws are all tapered from the mouth towards the recess longitudinal axis at a recess taper angle between 2.5° and 5.5°.

3. A screw and driver system according to claim 1, wherein the smallest drive-tier of the driver has drive flanks that are all tapered from the root towards the driver longitudinal axis at a tier taper angle between 0° and 1.0° less than said recess taper angle.

4. A screw and driver system according to claim 1, wherein the smallest drive-tier of the driving head has a tier taper angle of 3.7°±2.5°, and the smallest recess-tier of the screw recess has a recess taper angle of 4.3°±2.5°.

5. A screw and driver system according to claim 4, wherein the smallest drive-tier of the driving head has a tier taper angle of 3.7°±0.9°, and the smallest recess-tier of the screw recess has a recess taper angle of 4.3°±0.9°.

6. A screw and driver system according to claim 1, wherein:
the driver has a smallest-drive-fillet at the root between the smallest drive-tier and the base of said adjacent drive-tier, wherein the radius of the smallest-drive-fillet is between 0.1 and 0.5 mm,
the screw has a smallest-recess-chamfer at the mouth between the smallest drive-recess and the floor of said adjacent recess-tier, wherein the radius of the smallest-recess-chamfer is between 0.1 and 0.5 mm; and
the diameter of the smallest drive-tier of the driving head where the smallest-drive-fillet begins, is larger than the diameter of the smallest drive-recess where the smallest-screw-chamfer ends, by between 0.04 and 0.1 mm.

7. A screw and driver system according to claim 1, wherein:
the drive flanks of the smallest drive-tier engage with the driven flanks of the smallest drive-recess when the driver is mated with the screw, before the smallest-drive-fillet on the driver impacts the smallest-screw-chamfer in the screw, and before the base of the adjacent drive-tier of the driver impacts the floor of the adjacent recess-tier of the screw.

8. A screw and driver system according to claim 1, comprising at least three sizes of screw, being:
a largest size screw comprising three recess-tiers, being said smallest recess-tier formed in the floor of said adjacent recess-tier and a largest recess-tier, in whose floor said adjacent recess-tier is formed;
a middle size screw comprising two recess-tiers, being said smallest recess-tier formed in the floor of said adjacent recess-tier; and
a small size screw comprising one recess-tier, being said smallest recess-tier formed in the surface of said head of the screw; wherein
the driver comprises at least three said drive-tiers arranged to fit the corresponding recess-tiers of each screw size.
